(19) United States
(12) Patent Application Publication
(10) Pub. No.: US 2026/0195537 A1
(43) Pub. Date: Jul. 9, 2026

(54) EDGE COMPUTING BASED PREDICTIVE PROMPT CACHING FOR LARGE LANGUAGE MODEL

(71) Applicant: INTERNATIONAL BUSINESS MACHINES CORPORATION, ARMONK, NY (US)

(72) Inventors: Sarbajit Kumar Rakshit, Kolkata (IN); Sathya Santhar, Ramapuram (IN); Sridevi Kannan, Chennai (IN); Samuel Mathew Jawaharlal, Chennai (IN)

(21) Appl. No.: 19/013,586

(22) Filed: Jan. 8, 2025

(51) Int. Cl. G06F 40/30; H04L 67/50

(52) U.S. Cl. CPC G06F 40/30; H04L 67/535

(57) ABSTRACT

A cloud server processes ongoing user interaction patterns of a user and historical pattern of prompts from previous user interaction patterns of other users to predict and generate a probable next prompt based on one or more current prompts, via a predictive model. The probable next prompt is transmitted to an edge server for storage in a cache of the edge server.

### BACKGROUND

Embodiments relate to a method, system, and computer program product for edge computing based predictive prompt caching for large language model.

Large Language Models (LLMs) are advanced artificial intelligence (AI) systems designed to understand and generate human-like text based on the prompts they receive. These models are built on deep learning architectures, specifically transformers, which enable them to process and produce text with remarkable fluency and coherence.

Prompts are the inputs or queries given to LLMs, and the prompts guide the LLMs in generating relevant and contextually appropriate responses. LLMs have a vast array of applications, ranging from conversational agents and customer support to content creation and data analysis, making them an integral part of modern AI-driven solutions.

Mobile networks and other networks often employ edge computing. Edge computing allows devices in remote locations to process data at the “edge” of a network, either by the device or a local server. When data needs to be processed in the central datacenter, only the most important data is transmitted, and latency is reduced.

### SUMMARY

Provided are a method, system, and computer program product in which a cloud server processes ongoing user interaction patterns of a user and historical pattern of prompts from previous user interaction patterns of other users to predict and generate a probable next prompt based on one or more current prompts, via a predictive model. The probable next prompt is transmitted to an edge server for storage in a cache of the edge server.

In additional embodiments, the one or more current prompts is an input to the predictive model, wherein the probable next prompt is an output of the predictive model.

In yet additional embodiments, the probable next prompt is a predicted next prompt, wherein based on the predicted prompt, a transformer model that includes the predictive model generates responses for the predicted next prompt, and wherein the transformer model processes predicted prompts and generates contextually relevant responses, incorporating semantic understanding of the input.

In further embodiments, a hierarchical structure of the predicted prompts is maintained, and deletions from the cache occur not only based on scheduled time but also based on the hierarchical structure of the predicted prompts.

In yet further embodiments, the hierarchical structure is updated based on actual prompts when the actual prompts deviate from a prediction which would result in deletion of certain branches in the hierarchical structure that are likely to be skipped.

In certain embodiments, a plurality of probable next prompts comprise predicted prompts that are deleted in the cache based on a probability of occurrence of future prompts combined with idle time in the cache.

In further embodiments, a system cache of a client device of the user is used to store user specific predictions to free up storage space in edge servers.

### BRIEF DESCRIPTION OF THE DRAWINGS

Referring now to the drawings in which like reference numbers represent corresponding parts throughout:

FIG. 1 illustrates a block diagram of a computing environment, in accordance with certain embodiments.

FIG. 2 illustrates a block diagram that shows augmentation of a cache with predicted prompts, in accordance with certain embodiments.

FIG. 3 illustrates a block diagram that shows prediction of future prompts based on current prompts, in accordance with certain embodiments.

FIG. 4 illustrates a block diagram that shows prompts and responses, in accordance with certain embodiments.

FIG. 5 illustrates a block diagram that shows additional prompts and responses, in accordance with certain embodiments.

FIG. 6 illustrates a block diagram that shows exemplary embodiments in a transformer architecture, in accordance with certain embodiments.

FIG. 7 illustrates a block diagram that shows a transformer model for response generation, in accordance with certain embodiments.

FIG. 8 illustrates a block diagram that shows exemplary embodiments in a deep neural network, in accordance with certain embodiments.

FIG. 9 illustrates a block diagram that shows an interaction between an edge server and a cloud server, in accordance with certain embodiments.

FIG. 10 illustrates a block diagram that shows the processing of follow-up prompts, in accordance with certain embodiments.

FIG. 11 illustrates a flowchart that shows exemplary operations, in accordance with certain embodiments.

FIG. 12 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

LLMs are sophisticated AI systems designed to understand and generate text based on user prompts. These models are central to applications like chatbots, virtual assistants, and automated content generation. The effectiveness of these models hinges on their ability to quickly and accurately respond to user queries. However, the reliance on centralized cloud servers to process every prompt can lead to latency issues, and such latency issues are especially problematic in real-time applications where swift responses are crucial for maintaining user engagement.

Edge computing offers a solution to this challenge by processing data closer to the user, on local servers or devices rather than relying solely on centralized cloud infrastructure. By bringing computation to the “edge” of the network, closer to where the data is generated, edge computing can significantly reduce latency and bandwidth usage. This improvement in response times can greatly enhance the performance and user experience of applications powered by LLMs.

In certain mechanisms, edge computing is used to store frequently asked prompts and their responses locally. For example, a customer service bot might cache responses to common queries, such as, “What are your working hours?”, on local edge servers. This allows the system to provide quick answers without needing to access the central server for every request. Certain mechanisms focus on this approach, where the primary goal is to reduce latency by caching frequently used prompts and their corresponding responses at the edge.

However, current mechanisms do not generally involve predicting future prompts and dynamically storing these predicted prompts at the edge. Existing systems primarily handle static caching based on historical data of frequently used prompts. Such mechanisms do not account for the dynamic nature of user interactions and the potential for more sophisticated prompt handling through prediction. While current edge computing implementations for LLMs focus on reducing latency through caching frequently used prompts and responses, they lack the dynamic aspect of predicting and storing future prompts.

Certain embodiments provide approaches that use edge computing to not only store frequently asked prompts but also predict and cache future prompts dynamically. By employing predictive models that analyze ongoing user interaction patterns, certain embodiments anticipate upcoming queries and preloads responses at the edge. This dynamic storage of predicted prompts may further reduce latency and improve the responsiveness of LLMs in real-time applications, providing a more sophisticated and efficient solution for handling user queries. Introducing predictive caching at the edge for LLMs may significantly enhance response times and user experience and improve the operations of a computational device that executes LLMs.

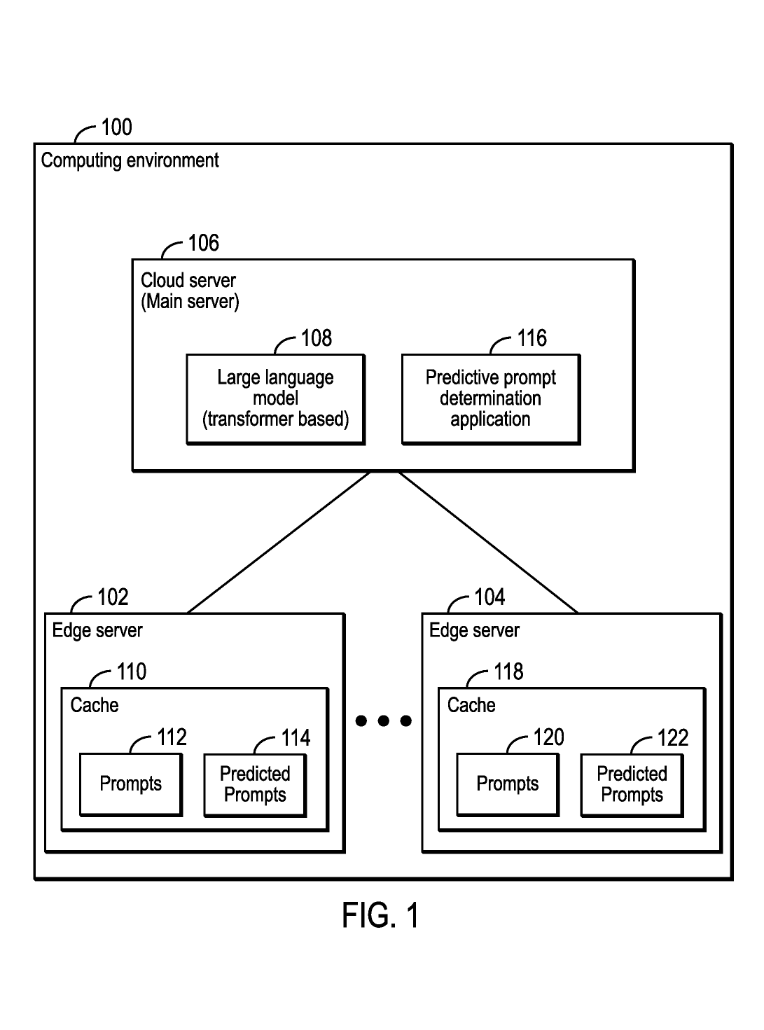

FIG. 1 illustrates a block diagram of a computing environment 100, in accordance with certain embodiments.

A plurality of edge servers 102, 104 are coupled to a cloud server 106 (also referred to as main server), where the cloud server executes a large language model 108 that is transformer based. The edge server 102 include a cache 110 in which prompts 112 and predicted prompts 114 are stored, where the predicted prompts 114 may have been received by the edge server 102 from the cloud server 106 in which a predictive prompt determination application 116 has determined the predictive prompts 114 via the LLM 108. The other edge server 104 has components including cache 118 that are similar to the cache 110 of the edge server 102 and performs similar operations related to the prompts 120 and the predicted prompts 122 stored in the cache 118. While two edge servers 102, 104 are shown, in additional embodiments there may be many more edge servers. The client devices (e.g., a cellular phone) of a plurality of users may communicate with the plurality of edge server 102, 104, and the plurality of edge servers 102, 104 may communicate with the cloud server 106.

The cloud server 106 and the edge servers 102, 104 may in certain embodiments comprise any suitable computational device known in the art such as a server, a personal computer, a laptop, a mainframe, etc. The LLM 108 that executes in the cloud server 106 may in certain embodiments be implemented in software, firmware, hardware or any combination thereof. In certain embodiments, the predictive prompt determination application 116 and the LLM 108 may be implemented in software, firmware, hardware, or a combination thereof.

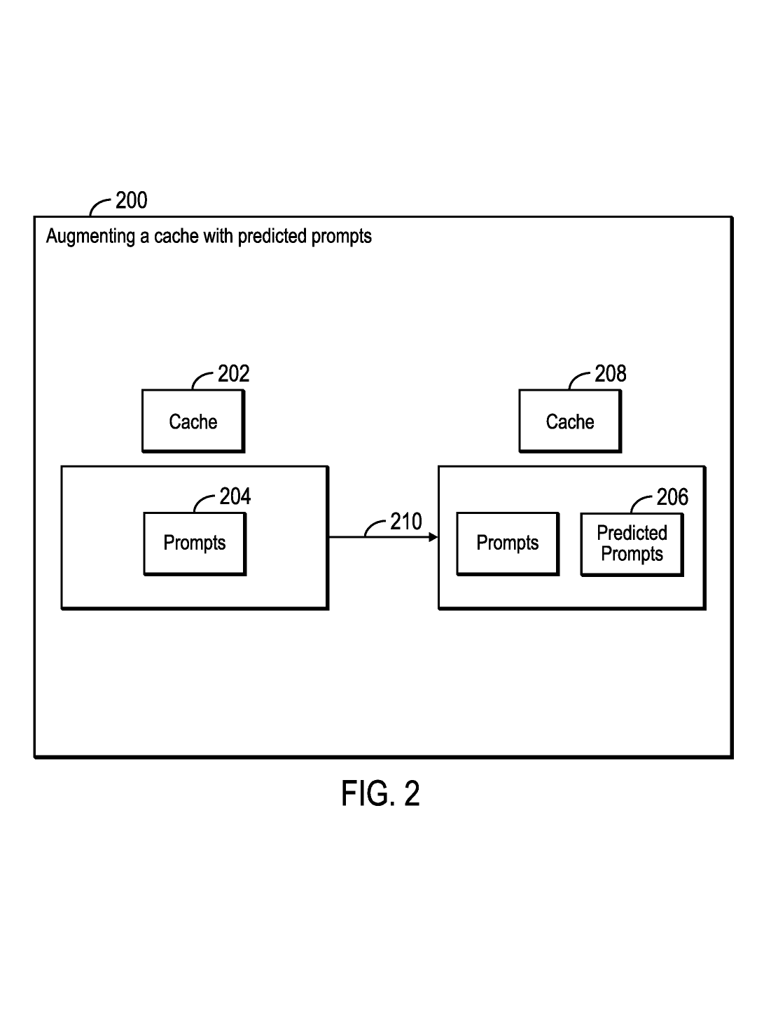

FIG. 2 illustrates a block diagram 200 that shows augmentation of a cache 202 that stores prompts 204 with predicted prompts 206, in accordance with certain embodiments. The new configuration of cache 202 with the predicted prompts 206 is shown via reference numeral 208.

The cache 110, 118 in the edge servers 102, 104 are augmented with predicted prompts via the cloud server 106. The process of augmentation with predicted prompts is shown in FIG. 2 by the arrow 210.

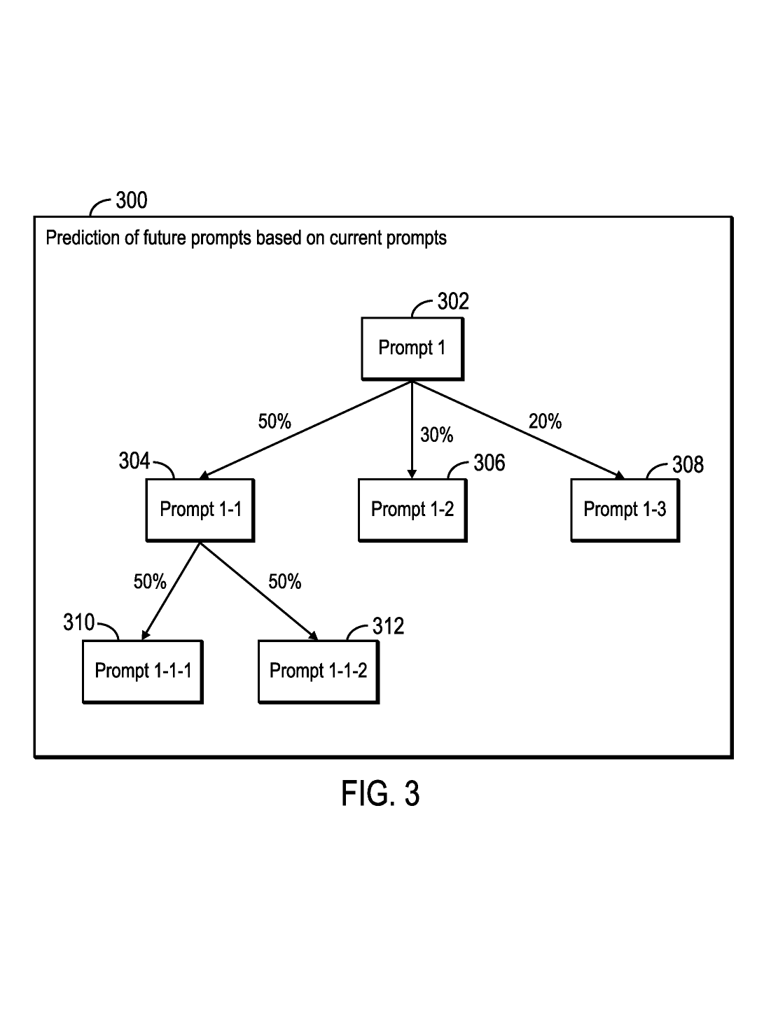

FIG. 3 illustrates a block diagram 300 that shows prediction of future prompts based on current prompts, in accordance with certain embodiments. The operations shown in FIG. 3 may be performed by cloud server.

A hierarchical graph that shows the probability of different predicted prompts that may occur after a prompt is shown. For example, after Prompt 1 302, the likelihood of Prompt 1-1 304 is 50%, the likelihood of Prompt 1-2 306 is 30% and likelihood of Prompt 1-3 308 is 20%. Similarly, after Prompt 1-1 304 the likelihood of Prompt 1-1-1 310 is 50% and the likelihood of Prompt 1-1-2 312 is 50%.

For example, in response to an initial prompt of “How do I reset my password?”, there may be the following predicted follow-up prompts analogous to that shown in FIG. 3

1. “Where can I find the 'Forgot Password' link?”

2. “Do I need to provide my email address to reset my password?”

3. “Is there a time limit for resetting my password?”

4. “Will I receive an email confirmation after resetting my password?”

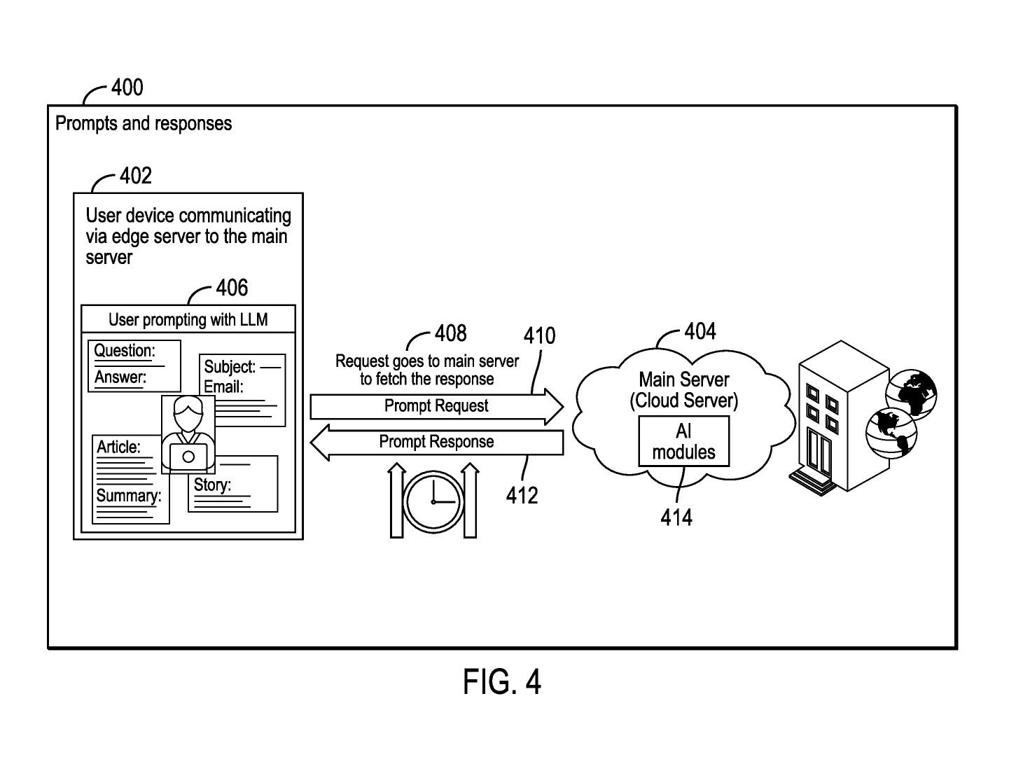

FIG. 4 illustrates a block diagram 400 that shows prompts and responses, in accordance with certain embodiments.

A user device 402 that is communicating via an edge server to a main server 404 is shown, where the main server 404 may comprise a cloud server 106 as shown in FIG. 1. The user of the user device 402 is shown prompting with a LLM as shown via reference numeral 406. The request from the user goes via the edge server to the main server 404 to fetch the response (as shown via reference numeral 408) and the request is referred to as the prompt request. The response that is referred to as the prompt response 412 is returned from the main server 404. A set of AI modules 414 is executed in the main server 404 to generate the responses. In certain embodiments, predicted prompts are also generated by the AI modules 414.

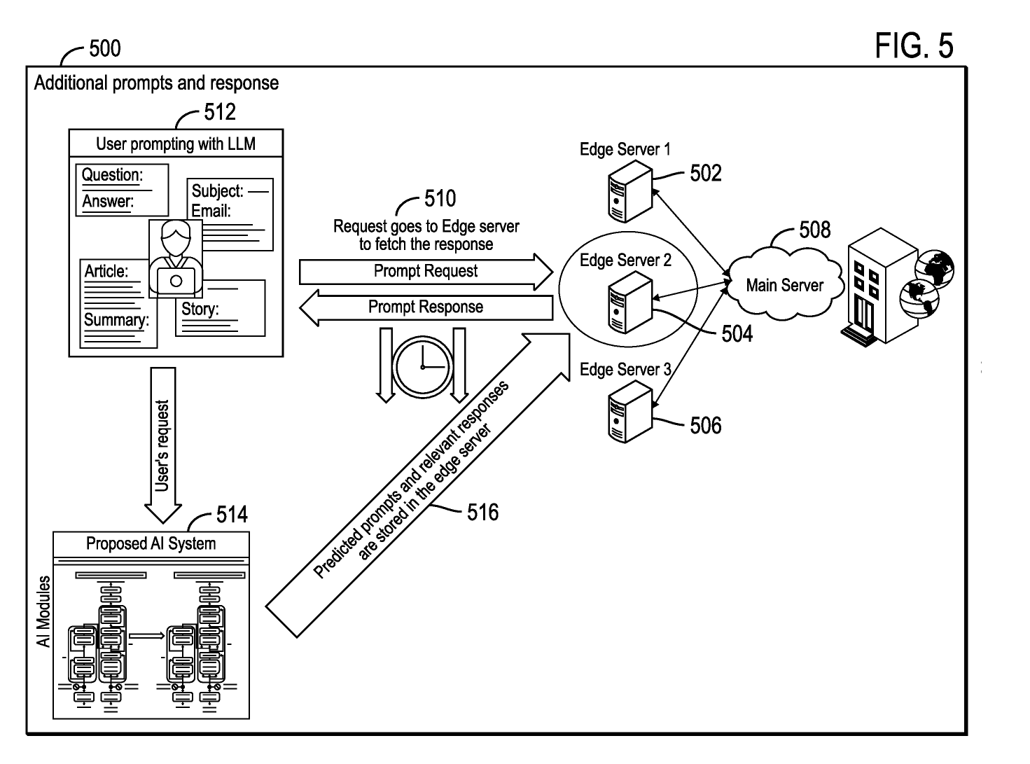

FIG. 5 illustrates a block diagram 500 that shows additional prompts and responses, in accordance with certain embodiments.

A plurality of edge servers 502, 504, 506 may communicate with a main server 508. Different users may communicate with different edge servers and the main server 508 may collect historical statistics on prompts and response from the plurality of users.

A request is shown being sent (reference numeral 510) via a user prompting with the LLM (shown via reference numeral 512) via an edge server 504.

The prompt request from the user is processed by an AI system 514 that executes in the main server 508 with interacting components in the edge server and user devices to return a relevant prompt response and predicted prompts to be stored in the edge server 504 (as shown via reference numeral 516).

The Artificial Intelligence modules 414 (the proposed AI system 514) executing in the main server 508 with components in the edge servers and used in the embodiments may have features as follows:

1. Transformer Model for Next Prompt Prediction:

(a) Utilizes a Transformer model to predict and generate the probable next prompt based on the current prompt text.

(b) This model takes the current prompt as input and outputs the most likely next prompt, leveraging the self-attention mechanism for contextual understanding.

2. Transformer Model for Response Generation:

(a) Deploys a second Transformer model designed to generate responses for the previously predicted next prompts.

(b) This model processes the predicted prompts and generates contextually relevant responses, incorporating the semantic understanding of the input.

3. Edge Server Storage for Predicted Prompts and Responses:

(a) Stores the predicted prompts and their corresponding responses in the edge servers, ensuring they are readily available for serving users.

(b) By caching this data locally, the edge servers can quickly respond to user queries, reducing latency and improving response time.

4. Deep Neural Network for Storage Optimization:

(a) Determines the optimal storage allocation for predicted follow-up prompts and frequently used prompts.

5. Edge Servers:

(a) Store and manage predicted prompts and responses based on DNN predictions, ensuring quick access and reduced latency.

6. Feedback Loop for Model Updating:

(a) Implements a feedback loop where the model compares the predicted next prompt with the actual next prompt from the user.

(b) Based on this feedback, update the model's response generation capability, and refine the storage of predicted prompts and responses in the edge servers.

The embodiments combine the predictive capabilities of Transformer models with edge computing infrastructure to optimize the responsiveness of AI-driven systems, ultimately enhancing user experience by reducing latency in prompt processing and response generation.

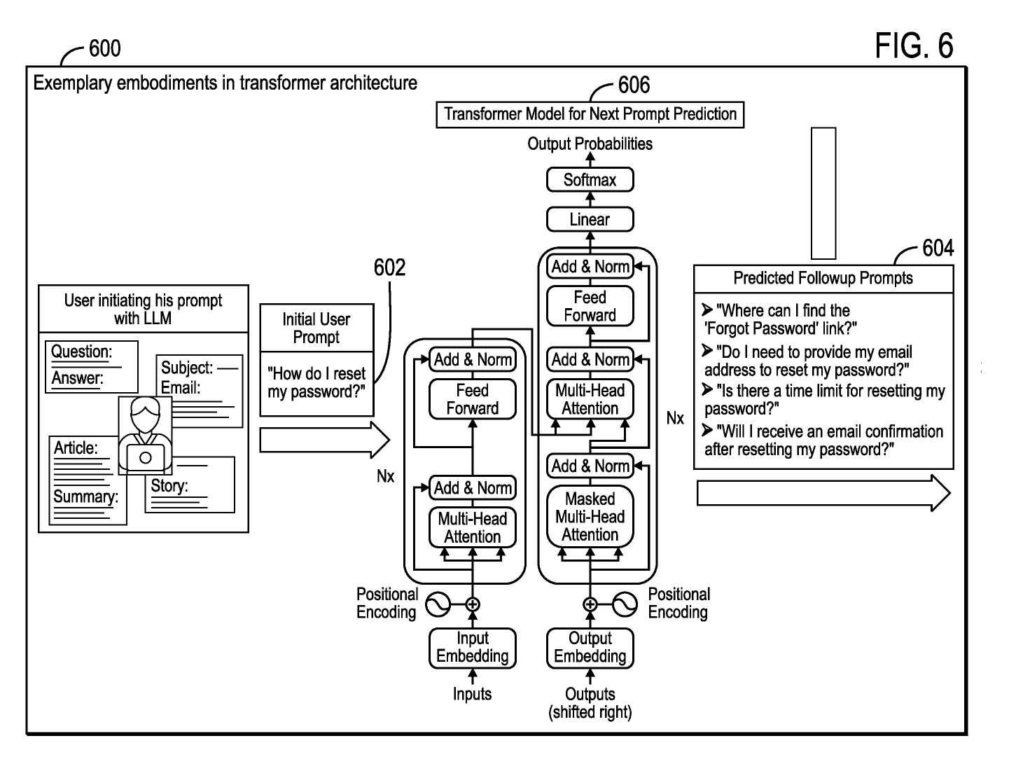

FIG. 6 illustrates a block diagram 600 that shows exemplary embodiments in a transformer architecture (first transformer model), in accordance with certain embodiments.

In a scenario where a user encounters difficulty accessing their online account, they prompt the platform's chat interface with “How do I reset my password?”. Anticipating the user's potential follow-up queries, the proposed model utilizes Transformer-based prediction to generate and store probable next prompts along with their relevant responses in the edge servers. Understanding the common sequence of user inquiries, the model predicts follow-up questions such as the location of the “Forgot Password” link, the requirement of providing an email address, the presence of time limits for password reset, and the confirmation receipt process. These predicted prompts and responses are preloaded into the edge servers, enabling the system to quickly provide relevant assistance to users when they ask similar questions in the future, thereby reducing latency and enhancing user experience.

For example, if the Initial Prompt is “How do I reset my password?” 602, then the predicted follow up prompts 604 may be as follows (as shown in FIG. 6):

1. “Where can I find the 'Forgot Password' link?”

2. “Do I need to provide my email address to reset my password?”

3. “Is there a time limit for resetting my password?”

4. “Will I receive an email confirmation after resetting my password?”

The architecture for performing the next prompt prediction and storing information in edge for reduced latency and response time using the AI modules may be achieved via transformer models and the generic transformer architecture and the processing details are provided first.

The details of the transformer architecture 606 are as follows:

Transformer Architecture: The model is based on the Transformer architecture, which consists of encoder and decoder layers. However, for autoregressive language modeling tasks like predicting the next sentence, only the decoder part is used.

Self-Attention Mechanism: The core of the Transformer architecture is the self-attention mechanism. It allows the model to weigh the importance of different words in the input sentence when generating the output.

Positional Encoding: Since Transformers do not inherently understand the order of words in a sequence, positional encoding is added to the input embeddings to provide the model with positional information.

Decoder Layers: The decoder layers take as input the embedded representation of the current sentence along with the output from the previous decoder layer. Each layer attends to different parts of the input sentence, capturing dependencies between words.

Output Layer: The output layer is a softmax layer that generates a probability distribution over the vocabulary for the next token. The token with the highest probability is selected as the predicted next word.

The process of prediction is as follows:

Input Encoding: The current sentence is tokenized and converted into numerical embeddings. These embeddings represent the semantics of the words in the sentence.

Positional Encoding: Positional encoding vectors are added to the input embeddings to provide positional information to the model.

Decoder Processing: The encoded input is fed into the decoder layers of the Transformer. Each layer processes the input and produces an output representation that captures the contextual information of the sentence.

Next Token Prediction: The output representation from the decoder layers is passed through the output layer, which generates a probability distribution over the vocabulary for the next token. The token with the highest probability is selected as the predicted next word. This word becomes the next input token for the model.

Repeat Process: The process is repeated iteratively, with the predicted token appended to the input sequence for the next prediction. This iterative process continues until a specified maximum sequence length is reached or a special end-of-sequence token is generated.

The AI models and operations are as follows:

Transformer Model for Next Prompt Prediction: The Transformer model serves as an important feature of the embodiments, enabling the prediction of the next probable prompt based on the user's current query. This model operates by processing the input prompt text using multiple decoder layers, each equipped with self-attention mechanisms to capture contextual dependencies and semantic relationships within the text. By analyzing patterns in user interactions and historical data, the model predicts the most likely follow-up question the user is likely to ask. For example, given the prompt “How do I reset my password?” the model predicts potential next prompts such as inquiries about the location of the “Forgot Password” link or the requirement of providing an email address for password reset. This prediction capability is crucial for preemptively addressing user queries and optimizing the responsiveness of the system.

In this context the following are the definitions, architecture, and operations that may be performed:

1. Input: The current prompt text provided by the user.

2. Processing: Utilize a Transformer model, such as GPT, to process the current prompt and predict the most probable next prompt.

3. Output: The predicted next prompt generated by the model.

4. Architecture Details: The Transformer model comprises encoder and decoder layers, focusing solely on the decoder for autoregressive language modeling.

Input embeddings of the current prompt are passed through multiple decoder layers, leveraging self-attention mechanisms to capture contextual dependencies and predict the next prompt.

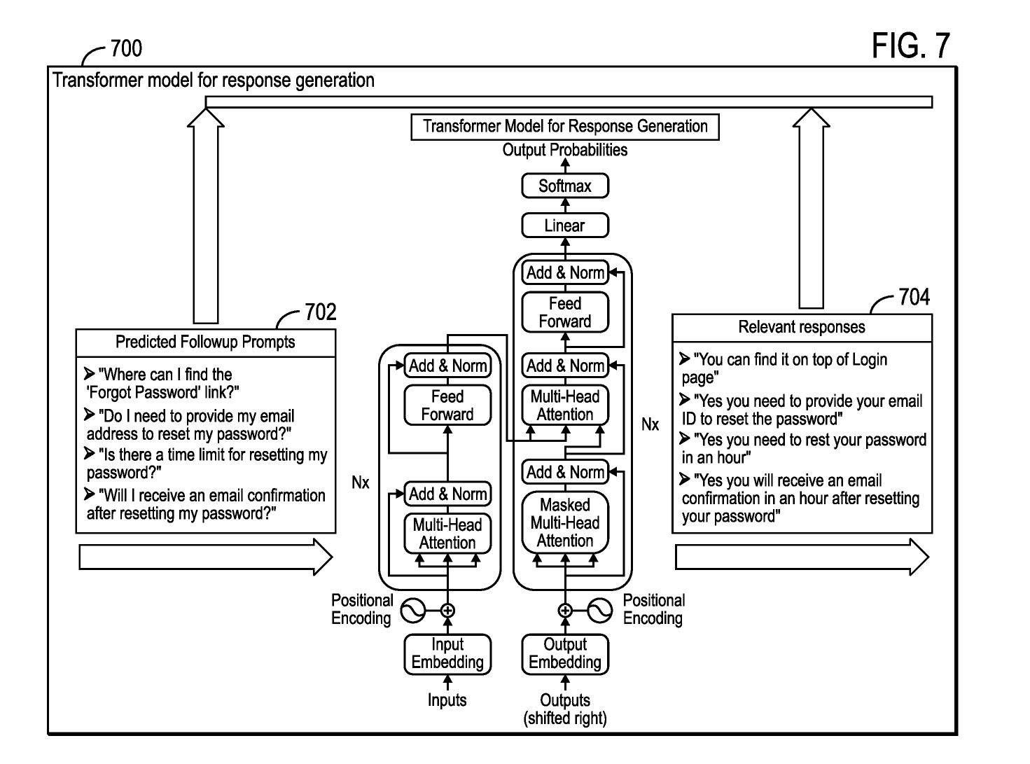

FIG. 7 illustrates a block diagram 700 that shows a transformer model (second transformer model) for response generation, in accordance with certain embodiments.

Once the next prompt is predicted by the first Transformer model, the subsequent step involves generating contextually relevant responses based on these predicted prompts. A separate Transformer model tailored for response generation is deployed for this purpose. This model takes the predicted next prompts as input and leverages its decoder layers to generate coherent and informative responses. By understanding the context provided by the predicted prompts, the model generates responses that address user inquiries effectively. For instance, in response to the predicted next prompt (Predicted Followup Prompts 702) regarding the “Forgot Password” link, the model generates a response 704 guiding the user to the appropriate location on the platform to initiate the password reset process. This capability ensures that the system can provide accurate and timely assistance to users, enhancing their overall experience.

In this context the input comprises predicted next prompts generated by the first Transformer model. The processing deploys a separate Transformer model designed specifically for generating responses based on input prompts. The output comprises contextually relevant responses corresponding to the input prompts.

The architecture details are similar to the first Transformer model, and this second transformer model is comprised of decoder layers optimized for response generation. It takes the predicted next prompts as input and generates responses using the self-attention mechanism to understand the context and semantics of the prompts.

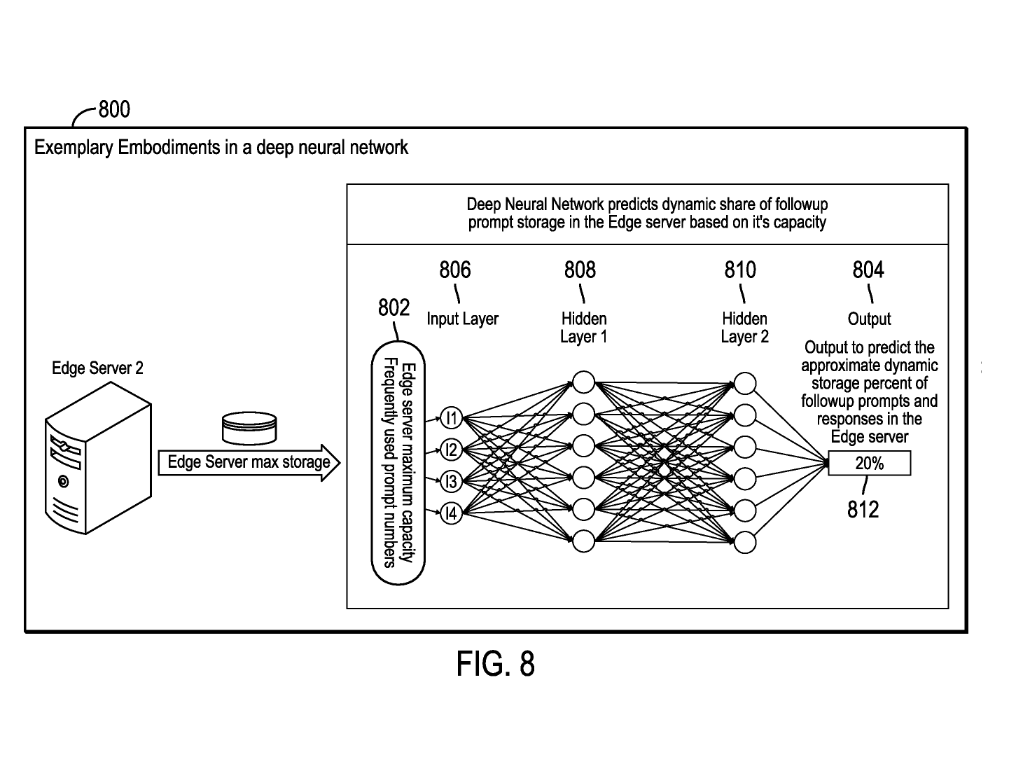

FIG. 8 illustrates a block diagram 800 that shows exemplary embodiments in a deep neural network, in accordance with certain embodiments.

Certain embodiments have a Deep neural network (DNN) to optimize the storage allocation on edge servers to balance frequently used prompts and predicted follow-up prompts. The features of FIG. 8 are described below:

Input 802: Edge server's maximum storage capacity and the count of frequently used prompts.

Processing: A deep neural network (DNN) determines the optimal dynamic storage percentage for follow-up prompts and responses.

Output 804: The predicted storage percentage for follow-up prompts and responses.

Architecture Details: The architecture of the Deep Neural Network (DNN) used for optimizing storage on edge servers consists of multiple layers designed for input processing, feature extraction, and prediction. The input layer 806 takes the edge server's storage capacity and frequency data of prompt usage. This is followed by several hidden layers 808, 810 with neurons employing activation functions like Rectified Linear Unit (ReLU) to capture complex patterns and relationships within the data. The final layer is a fully connected output layer that produces the optimal storage allocation percentages for frequently used prompts and predicted follow-up prompts. The model is trained using backpropagation and gradient descent to minimize the prediction error, ensuring accurate and efficient storage management. Regular updates and fine-tuning are performed based on new data and feedback to maintain optimal performance.

Working Functionality: The DNN takes into account the edge server's capacity and the frequency of prompt usage to calculate an optimal storage strategy. For example, if an edge server can store prompts and responses, the DNN may allocate 80% of the storage for the most frequently queried prompts and the remaining 20% for dynamically predicted follow-up prompts (as shown via reference numeral 812). This ensures a balance between immediate responsiveness for common queries and preparedness for anticipated future queries, optimizing the use of edge storage resources.

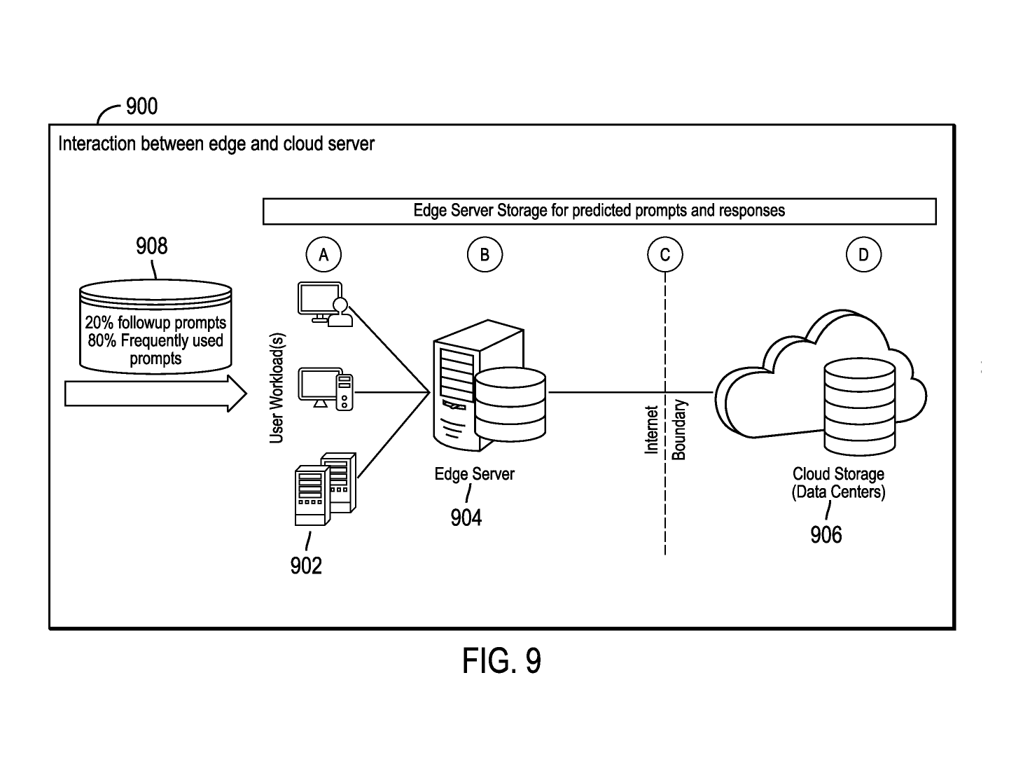

FIG. 9 illustrates a block diagram 900 that shows an interaction between an edge server and a cloud server, in accordance with certain embodiments. The user workload 902 at client machine are transmitted via the edge server 904 to cloud storage 906 where data centers are located.

Edge server storage for predicted prompts and responses are implemented in certain embodiments. To optimize response time and reduce latency, the predicted prompts and their corresponding responses are stored in edge servers 904. Based on the DNN's output, the edge server dynamically allocates storage space. For instance, if the DNN predicts that 20% of storage should be reserved for follow-up prompts, the edge server adjusts its cache to store these predictions and responses, while the remaining 80% is used for frequently accessed prompts (reference numeral 908). This dynamic allocation ensures efficient use of storage, enabling quick responses to both common and anticipated future user queries, thereby reducing latency and enhancing performance. This edge server storage mechanism ensures that the system can quickly access and retrieve relevant prompts and responses without relying on centralized cloud servers, minimizing network latency. The edge servers maintain a cache of predicted prompts and responses, enabling efficient retrieval based on user queries. By leveraging distributed database technologies or in-memory caching solutions, the edge servers ensure rapid access to the most relevant information. This approach not only enhances the responsiveness of the system but also reduces the load on centralized servers, improving overall scalability and resource utilization.

The predicted prompts and their corresponding responses are stored in edge servers for quick access and reduced latency. The edge servers maintain a cache of predicted prompts and responses, ensuring they are readily available for serving users without needing to access centralized cloud servers. The storage mechanism can be optimized for efficient retrieval and updating of cached data, leveraging distributed database technologies or in-memory caching solutions. In the context of the updating of cached data, deletions from the cache may occur not only based on scheduled time but also based on the hierarchical structure of predicted prompts. The hierarchical structure may be updated based on actual prompts when the actual prompts deviate from a prediction which would result in deletion of certain branches in the hierarchical structure that are likely to be skipped. Predicted prompts may be deleted in the cache based on a probability of occurrence of future prompts combined with idle time in the cache.

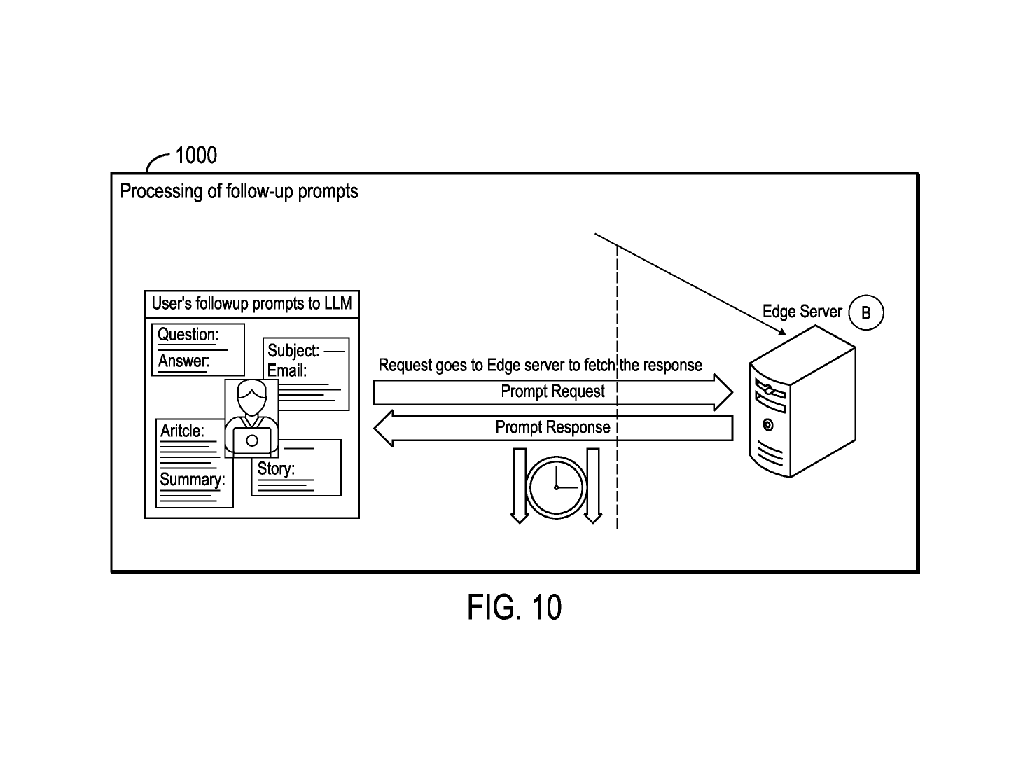

FIG. 10 illustrates a block diagram 1000 that shows the processing of follow-up prompts, in accordance with certain embodiments.

Certain features are as follows include a feedback loop for model updating in which continuous improvement is implemented by the embodiments. A feedback loop is implemented to collect user feedback and update the models and cached data accordingly. User interactions, including the actual next prompts provided by users, are collected and used to evaluate the accuracy of the predicted prompts and responses. This feedback loop informs model updates, such as fine-tuning the prediction and response generation models based on user interactions and continuously refining the cached data stored in edge servers. By incorporating user feedback into the model training process, the system evolves over time, adapting to changing user preferences and improving its ability to predict and generate relevant prompts and responses. This iterative approach ensures that the system remains responsive and effective, providing users with accurate and personalized assistance. Therefore, a feedback loop to update the model based on user interactions and performance evaluation is implemented in certain embodiments.

The integration of next prompt prediction and dynamic storage management through advanced AI modules, including Transformer models and a Deep Neural Network (DNN), significantly enhances the efficiency and responsiveness of edge computing systems. By predicting likely follow-up prompts and generating relevant responses, the system ensures that user queries are addressed swiftly and accurately. The DNN optimizes the storage allocation on edge servers, balancing between frequently used prompts and anticipated future queries, thereby reducing latency and improving resource utilization. This innovative approach not only streamlines user interactions but also leverages the power of edge computing to deliver a seamless, real-time user experience, marking a substantial advancement in AI-driven customer service solutions.

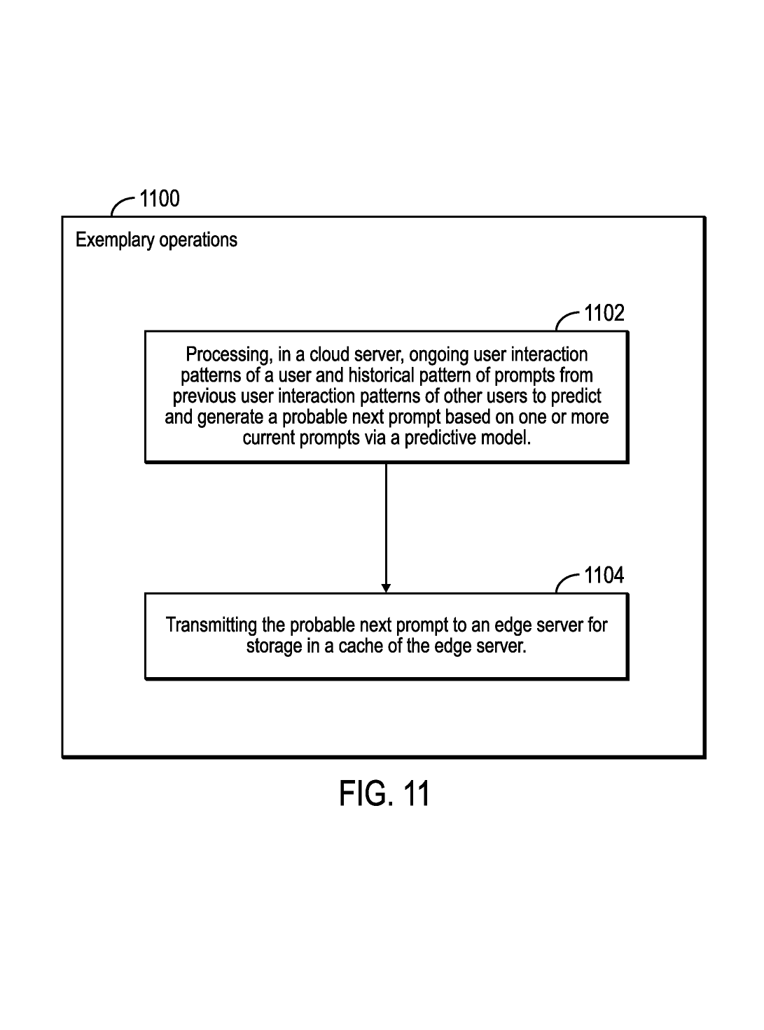

FIG. 11 illustrates a flowchart 1100 that shows exemplary operations, in accordance with certain embodiments.

Control starts at block 1102 in which a cloud server 106 processes ongoing user interaction patterns of a user and historical pattern of prompts from previous user interaction patterns of other users to predict and generate a probable next prompt based on one or more current prompts via a predictive model. The probable next prompt is transmitted (at block 1104) to an edge server 102 for storage in a cache of the edge server.

In certain embodiments, the one or more current prompts is an input to the predictive model, wherein the probable next prompt is an output of the predictive model. The probable next prompt may be a predicted next prompt, where based on the predicted prompt, a transformer model that includes the predictive model generates responses for the predicted next prompt, and where the transformer model processes predicted prompts and generates contextually relevant responses, incorporating semantic understanding of the input.

In certain embodiments, a hierarchical structure of the predicted prompts is maintained, and deletions from the cache occur not only based on scheduled time but also based on the hierarchical structure of the predicted prompts. The hierarchical structure may be updated based on actual prompts when the actual prompts deviate from a prediction which would result in deletion of certain branches in the hierarchical structure that are likely to be skipped.

A plurality of probable next prompts may comprise predicted prompts that are deleted in the cache based on a probability of occurrence of future prompts combined with idle time in the cache. In certain embodiments, a system cache of a client device of the user is used to store user specific predictions to free up storage space in edge servers.

Therefore, FIGS. 1-11 illustrate embodiments to store predictive prompts generated by an LLM in edge server, and this improves the performance of computing systems.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

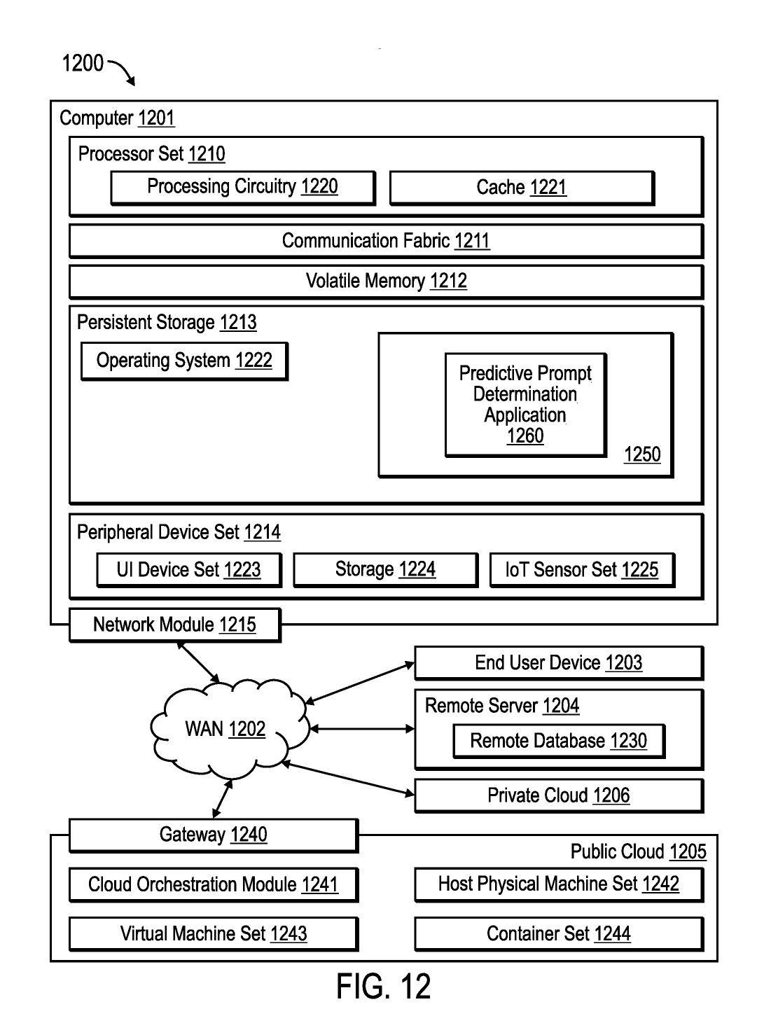

In FIG. 12, a computing environment 1200 contains an example of an environment for the execution of at least some of the computer code (block 1250) involved in performing the operations for predictive prompt determination application 1260 that performs operations shown in FIGS. 1-11.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer, and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The letter designators, such as i, is used to designate a number of instances of an element may indicate a variable number of instances of that element when used with the same or different elements.

The terms "an embodiment", "embodiment", "embodiments", "the embodiment", "the embodiments", "one or more embodiments", "some embodiments", and "one embodiment" mean "one or more (but not all) embodiments of the present invention(s)" unless expressly specified otherwise.

The terms "including", "comprising", “having” and variations thereof mean "including but not limited to", unless expressly specified otherwise.

The enumerated listing of items does not imply that any or all of the items are mutually exclusive, unless expressly specified otherwise.

The terms "a", "an" and "the" mean "one or more", unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method, comprising:
processing, in a cloud server, ongoing user interaction patterns of a user and historical pattern of prompts from previous user interaction patterns of other users to predict and generate a probable next prompt based on one or more current prompts, via a predictive model; and
transmitting the probable next prompt to an edge server for storage in a cache of the edge server.

2. The method of claim 1, wherein the one or more current prompts is an input to the predictive model, and wherein the probable next prompt is an output of the predictive model.

3. The method of claim 2, wherein the probable next prompt is a predicted next prompt, wherein based on the predicted prompt, a transformer model that includes the predictive model generates responses for the predicted next prompt, and wherein the transformer model processes predicted prompts and generates contextually relevant responses, incorporating semantic understanding of the input.

4. The method of claim 3, wherein a hierarchical structure of the predicted prompts is maintained, and deletions from the cache occur not only based on scheduled time but also based on the hierarchical structure of the predicted prompts.

5. The method of claim 4, wherein the hierarchical structure is updated based on actual prompts when the actual prompts deviate from a prediction which would result in deletion of certain branches in the hierarchical structure that are likely to be skipped.

6. The method of claim 1, wherein a plurality of probable next prompts comprise predicted prompts that are deleted in the cache based on a probability of occurrence of future prompts combined with idle time in the cache.

7. The method of claim 1, wherein a system cache of a client device of the user is used to store user specific predictions to free up storage space in edge servers.

8. A system, comprising:
a memory; and
a processor coupled to the memory, wherein the processor performs operations, the operations comprising:
processing, in a cloud server, ongoing user interaction patterns of a user and historical pattern of prompts from previous user interaction patterns of other users to predict and generate a probable next prompt based on one or more current prompts, via a predictive model; and
transmitting the probable next prompt to an edge server for storage in a cache of the edge server.

9. The system of claim 8, wherein the one or more current prompts is an input to the predictive model, and wherein the probable next prompt is an output of the predictive model.

10. The system of claim 9, wherein the probable next prompt is a predicted next prompt, wherein based on the predicted prompt, a transformer model that includes the predictive model generates responses for the predicted next prompt, and wherein the transformer model processes predicted prompts and generates contextually relevant responses, incorporating semantic understanding of the input.

11. The system of claim 10, wherein a hierarchical structure of the predicted prompts is maintained, and so deletions from the cache occur not only based on scheduled time but also based on the hierarchical structure of the predicted prompts.

12. The system of claim 11, wherein the hierarchical structure is updated based on actual prompts when the actual prompts deviate from a prediction which would result in deletion of certain branches in the hierarchical structure that are likely to be skipped.

13. The system of claim 8, wherein a plurality of probable next prompts comprise predicted prompts that are deleted in the cache based on a probability of occurrence of future prompts combined with idle time in the cache.

14. The system of claim 8, wherein a system cache of a client device of the user is used to store user specific predictions to free up storage space in edge servers.

15. A computer program product comprising a computer readable storage medium having computer readable program code embodied therewith, wherein the computer readable program code when executed by a processor performs operations, the operations comprising:
processing, in a cloud server, ongoing user interaction patterns of a user and historical pattern of prompts from previous user interaction patterns of other users to predict and generate a probable next prompt based on one or more current prompts, via a predictive model; and
transmitting the probable next prompt to an edge server for storage in a cache of the edge server.

16. The computer program product of claim 15, wherein the one or more current prompts is an input to the predictive model, and wherein the probable next prompt is an output of the predictive model.

17. The computer program product of claim 16, wherein the probable next prompt is a predicted next prompt, wherein based on the predicted prompt, a transformer model that includes the predictive model generates responses for the predicted next prompt, and wherein the transformer model processes predicted prompts and generates contextually relevant responses, incorporating semantic understanding of the input.

18. The computer program product of claim 17, wherein a hierarchical structure of the predicted prompts is maintained, and deletions from the cache occur not only based on scheduled time but also based on the hierarchical structure of the predicted prompts.

19. The computer program product of claim 18, wherein the hierarchical structure is updated based on actual prompts when the actual prompts deviate from a prediction which would result in deletion of certain branches in the hierarchical structure that are likely to be skipped.

20. The computer program product of claim 15, wherein a plurality of probable next prompts comprise predicted prompts that are deleted in the cache based on a probability of occurrence of future prompts combined with idle time in the cache.
